(19) United States
(12) Patent Application Publication
(10) Pub. No.: US 2010/0134411 A1
(43) Pub. Date: Jun. 3, 2010

(54) Information processing apparatus and information processing method

(75) Inventors: Takeo Tsumura, Tokyo (JP); Jun Maruo, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/590,903

(22) Filed: Nov. 16, 2009

(30) Foreign Application Priority Data
Dec. 3, 2008 (JP) P2008-308799

(51) Int. Cl. G09G 5/00

(52) U.S. Cl. 345/156

(57) ABSTRACT

An information processing apparatus is provided which includes an image send unit for displaying a 3D image of a remote operation device as a virtual remote controller, at least one imaging unit for taking an image of a user, a 3D image detection unit for detecting a user's motion based on a video taken by the imaging unit, an instruction detection unit for determining whether the user has pressed a predetermined operation button arranged on the virtual remote controller, based on a detection result by the 3D image detection unit and a position of the predetermined operation button arranged on the virtual remote controller displayed by the image send unit, and an instruction execution unit for performing a predetermined processing corresponding to the user-pressed operation button on the virtual remote controller based on a determination result by the instruction detection unit.

### BACKGROUND OF THE INVENTION

1. Field of the Invention

The present invention relates to an information processing apparatus and an information processing method.

2. Description of the Related Art

In recent years, along with the improved functions of an electric device, the buttons arranged in a remote operation device (referred to as remote controller below) of the electric device have become more complicated. For example, in the case of a television, there are arranged, in many cases, operation buttons corresponding not only to the operations of a channel or voice/power supply but also various functions of a television receiver or external devices connected thereto such as program guide operation, recording operation, image quality/sound quality switching, preference setting. Further, there is provided a simple remote controller on which only operation buttons corresponding to minimum required functions are arranged, but when utilizing other functions, a user needs to operate another remote controller in the end. Thus, a remote controller of an electric device including a variety of different functions has a problem that it lacks convenience for the user.

There is disclosed in, for example, Japanese Patent Application Laid-Open No. 2006-014875 or the like a technique that enables the user to give an instruction of a predetermined processing to an electric device without using a remote controller. Japanese Patent Application Laid-Open No. 2006-014875 discloses therein an information processing apparatus capable of capturing a user's operation by an imaging apparatus and performing a predetermined processing depending on the user's operation. For example, this technique is already utilized in the game device such as EYETOY PLAY (registered trademark under Sony Corporation). The user can give an instruction of a predetermined processing to the game device by gesturing an operation corresponding to a desired processing even without using a remote controller.

### SUMMARY OF THE INVENTION

However, even when the technique described in Japanese Patent Application Laid-Open No. 2006-014875 is applied to an AV device such as television or personal computer, user's convenience is not necessarily improved. This is because if the user does not grasp all the complicated operations corresponding to all the functions provided in the device, he/she cannot give an instruction of a desired processing to the device. For example, in the case of an electric device connected to a plurality of external devices, such as television, it is remarkably difficult to request the user to grasp the operations corresponding to the functions provided in all the external devices. In other words, the user cannot give an instruction of a predetermined processing to the device through an intuitive operation like when operating a physical remote controller. As a result, there was a problem that it is more convenient for the user to operate a physical remote controller in the end and the aforementioned technique cannot be efficiently utilized.

Thus, the present invention has been made in terms of the above problems, and it is desirable for the present invention to provide an novel and improved information processing apparatus and information processing method capable of performing a predetermined processing depending on user's intuitive operation contents for a virtual remote controller displayed as 3D image and thereby improving convenience of the user's device operation.

According to an embodiment of the present invention, there is provided an information processing apparatus including an image send unit for displaying a 3D image of a remote operation device as a virtual remote controller, at least one imaging unit for taking an image of a user, a 3D image detection unit for detecting a user's motion based on a video taken by the imaging unit, an instruction detection unit for determining whether the user has pressed a predetermined operation button arranged on the virtual remote controller, based on a detection result by the 3D image detection unit and a position of the predetermined operation button arranged on the virtual remote controller displayed by the image send unit, and an instruction execution unit for performing a predetermined processing corresponding to the user-pressed operation button on the virtual remote controller based on a determination result by the instruction detection unit.

With the above structure, the information processing apparatus can display a 3D image of a remote operation device as virtual remote controller by the image send unit. Further, the information processing apparatus can take an image of the user by at least one imaging unit. The information processing apparatus can detect a user's motion by the 3D image detection unit based on the video taken by the imaging unit. The information processing apparatus can determine whether the user has pressed a predetermined operation button arranged on the virtual remote controller based on a detection result by the 3D image detection unit and a position of the predetermined operation button arranged on the virtual remote controller displayed by the image send unit. Furthermore, the information processing apparatus can perform a predetermined processing corresponding to a user-pressed operation button on the virtual remote controller by the instruction execution unit.

The information processing apparatus may further include a shape detection unit for specifying a user in an imaging region of the imaging unit by detecting part of the user's body based on a video taken by the imaging unit and comparing the detected part with previously registered information on parts of the user's body. The image send unit may display a previously registered virtual remote controller adapted to the user specified by the shape detection unit.

The information processing apparatus may further include a sound collection unit such as microphone for collecting a voice, and a voice detection unit for specifying a user who has generated the voice collected through the sound collection unit by comparing the voice collected by the sound collection unit with previously registered information on a user's voice. The image send unit may display a previously registered virtual remote controller adapted to the user specified by the voice detection unit.

The image send unit may change a shape of the virtual remote controller, and kinds or positions of operation buttons to be arranged on the virtual remote controller based on a determination result by the instruction detection unit.

The image send unit may change and display a color and/or shape of only an operation button which is determined to have been pressed by the user in the instruction detection unit among the operation buttons arranged on the virtual remote controller.

The image send unit may change a display position of the virtual remote controller in response to the user's motion such that the virtual remote controller is displayed to the user detected by the 3D image detection unit.

The image send unit may change a display position of the virtual remote controller depending on a user's operation when the user's operation detected by the 3D image detection unit matches with a previously registered predetermined operation corresponding to an instruction of changing the display position of the virtual remote controller.

The instruction execution unit may power on the information processing apparatus when a user's operation detected by the 3D image detection unit matches with a previously registered predetermined operation corresponding to the power-on instruction.

The instruction execution unit may power on the information processing apparatus when a sound detected by the voice detection unit matches with a previously registered predetermined sound corresponding to the power-on instruction.

The information processing apparatus may further include an external device's remote controller specification input unit for acquiring information on a remote controller specification of an external device operating in association with the information processing apparatus. The image send unit may display a virtual remote controller on which operation buttons corresponding to predetermined functions provided in the external device are arranged, based on the information on a remote controller specification of the external device.

When multiple users are present in an imaging region of the imaging unit, the image send unit may display a previously registered virtual remote controller adapted to only one user to the user.

When multiple users are present in an imaging region of the imaging unit, the image send unit may display previously registered virtual remote controllers adapted to the respective users to each user at the same time.

According to another embodiment of the present invention, there is provided an information processing method including the steps of displaying a 3D image of a remote operation device as a virtual remote controller, continuously taking an image of a user by at least one imaging unit, detecting a user's motion based on a video taken by the imaging step, determining whether the user has pressed a predetermined operation button arranged on the virtual remote controller based on a detection result by the 3D image detection step and a position of the predetermined operation button arranged on the virtual remote controller displayed by the image send step, and executing a predetermined processing corresponding to the user-pressed operation button on the virtual remote controller based on a determination result by the instruction detection step.

As described above, according to the present invention, it is possible to improve convenience of a user's device operation by performing a predetermined processing depending on user's intuitive operation contents for a virtual remote controller displayed as a 3D image.

### BRIEF DESCRIPTION OF THE DRAWINGS

FIG. 1 is an explanatory diagram showing a usage concept by a user of a television 100 according to one embodiment of the present invention;

FIG. 2 is a block diagram showing one example of a functional structure of the television 100 according to the embodiment;

FIG. 3 is a flowchart showing one example of a flow of a processing performed by the television 100 according to the embodiment;

FIG. 4 is an explanatory diagram showing how a display of a virtual remote controller 200 is appropriately changed by a user according to the embodiment;

FIG. 5 is an explanatory diagram showing a concept for displaying the virtual remote controller 200 to only one user among multiple users according to the present embodiment;

FIG. 6 is an explanatory diagram showing a concept for displaying the different virtual remote controllers 200 to multiple users viewing the television 100 at the same time according to the embodiment; and

FIG. 7 is a block diagram showing one example of a hardware structure of the television 100 according to the embodiment.

### DETAILED DESCRIPTION OF THE EMBODIMENTS

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted. Description will be given in the following order.

1. Outline of embodiment of the present invention

2. Functional structure of television 100 according to one embodiment

3. Processing flow by television 100

4. Usage example of television 100

5. Hardware structure of information processing apparatus

6. Conclusions

### 1. OUTLINE OF EMBODIMENT OF THE PRESENT INVENTION

The outline of one embodiment will be first described prior to explaining an information processing apparatus according to the present embodiment of the present invention in detail. In the following explanation, a television receiver 100 (referred to as television 100 below) will be described as one example of the information processing apparatus according to the embodiment of the present invention, but the present invention is not limited thereto. The television 100 according to the present embodiment is not limited to a specific information processing apparatus as long as it is an electric device capable of utilizing a remote controller to make an operation instruction, such as personal computer, monitor device or game device.

As stated above, in recent years, along with diversified functions of various information processing apparatuses such as television, record/playback device and personal computer, operation buttons arranged on a remote controller have also become more complicated. For example, in the case of an electric device connected to multiple external devices, such as television, in many cases, a remote controller of a television is provided with not only operation buttons corresponding to many functions provided in the television but also operation buttons corresponding to various functions provided in the external devices. In such a case, there is a problem that many operation buttons unnecessary for the user are present and convenience of the device operation is bad. Further, required operation buttons are different depending on a user utilizing the information processing apparatus and are not uniformly determined. For example, a remote controller convenient for elderly persons is different from that convenient for children. Further, a remote controller convenient for users who frequently use a playback device externally connected to a television is different from that convenient for users who frequently view a specific TV channel.

In order to solve such problems, there is the need of providing a physical remote controller main body adapted to individual user to each user, which is practically difficult.

On the other hand, there is assumed that the technique described in aforementioned Japanese Patent Application Laid-Open No. 2006-014875 is utilized to capture a user's operation by an imaging device and to perform a predetermined processing corresponding to the operation, thereby eliminating the need of the physical remote controller main body. However, the user needs to grasp all the operations corresponding to the functions provided in the device, which is not necessarily convenient for all the users. For example, user-required operations are different depending on a manufacturer or type of a used device. Thus, the user cannot give an instruction of a predetermined processing to the device through an intuitive operation like when operating a typical physical remote controller main body. Consequently, there was a problem that even when the technique is applied to a widely-used information processing apparatus such as television or personal computer, the convenience of the device operation cannot be improved.

The television 100 according to one embodiment of the present invention can solve the problems. In other words, the television 100 according to the present embodiment performs a predetermined processing depending on user's intuitive operation contents for a virtual remote controller 200 displayed as 3D image, thereby improving convenience of the user's device operation. Specifically, the television 100 displays a 3D image of a pseudo remote controller (referred to as virtual remote controller 200), recognizes a user's operation on the operation buttons arranged on the virtual remote controller 200 by an imaging device, and performs a predetermined processing depending on the user's operation.

More specifically, the television 100 displays a 3D image of the remote controller on which the operation buttons corresponding to various devices are arranged, and presents it to the user as the virtual remote controller 200. A method for presenting the virtual remote controller 200 to the user includes a method in which a user puts a pair of glasses having different polarization characteristics for each glass, which is described in Japanese Patent Application Laid-Open No. 2002-300608, a method that does not need a pair of glasses, which is described in Japanese Patent Application Laid-Open No. 2004-77778, and the like. Further, a hologram technique may be utilized. However, in the present embodiment, the 3D image display method is not limited to a specific method as long as it can present a 3D image of the remote controller to the user.

The television 100 can further take an image of a user's operation by an imaging device. Thus, the television 100 can recognize the user's operation at a display position of the virtual remote controller 200. Therefore, the television 100 can recognize the user's operation on the virtual remote controller 200 by taking an image of the user's operation. Consequently, the television 100 can perform a predetermined processing depending on the user's operation contents of the virtual remote controller 200. In other words, the user can give an instruction of a predetermined processing to the television 100 through an intuitive operation like when operating a physical remote controller main body.

Since the virtual remote controller 200 presented to the user is just a pseudo 3D image, the television 100 can display the virtual remote controller 200 on which only the operation buttons suitable for each user are arranged. In other words, the television 100 can present the virtual remote controller 200 suitable for a user utilizing the apparatus to each user. For example, the virtual remote controller 200 on which only simple operation buttons are arranged can be displayed for elderly persons or children and the virtual remote controller 200 on which only operation buttons corresponding to the functions provided in the playback device are arranged can be displayed for the users utilizing the externally connected playback device.

Further, the television 100 can dynamically change the virtual remote controller 200 to be presented to the user depending on the user's operation contents for the virtual remote controller 200. For example, when the user presses the power supply button of the playback device in viewing a TV program, the television 100 can automatically change the display from the virtual remote controller 200 for television to the virtual remote controller 200 for playback device.

As a result, the user can operate the television 100 by moving his/her finger or the like on the virtual remote controller 200 according to his/her preference or desired operation. In other words, the user can operate the television 100 though an intuitive operation like when operating a typical physical remote controller.

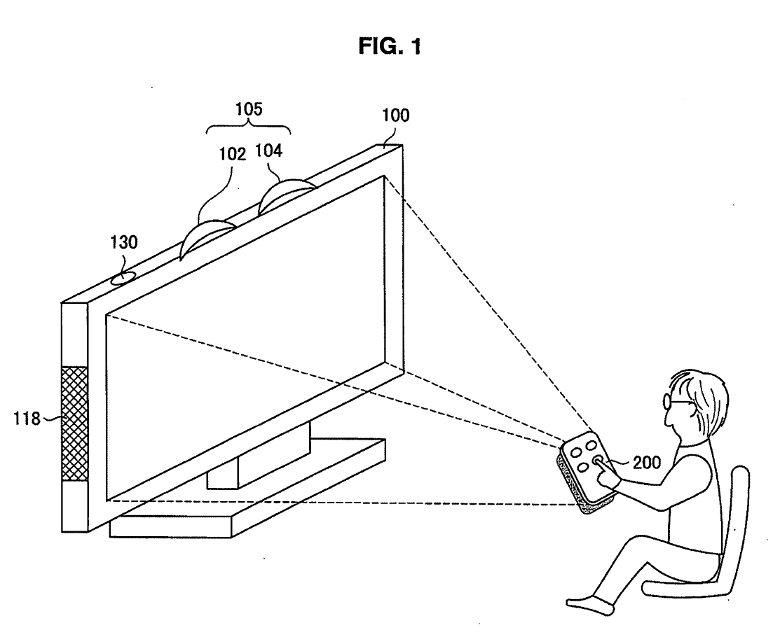

FIG. 1 is an explanatory diagram showing a usage concept by the user of the television 100 having the above characteristics. With reference to FIG. 1, it can be seen that the television 100 displays the virtual remote controller 200 for the user. Thus, the user can instruct the television 100 to perform a predetermined processing by intuitively moving his/her finger on the virtual remote controller 200 like when operating an actual physical remote controller.

The television 100 having the above characteristics will be described below in detail.

### 2. FUNCTIONAL STRUCTURE OF TELEVISION 100 ACCORDING TO ONE EMBODIMENT

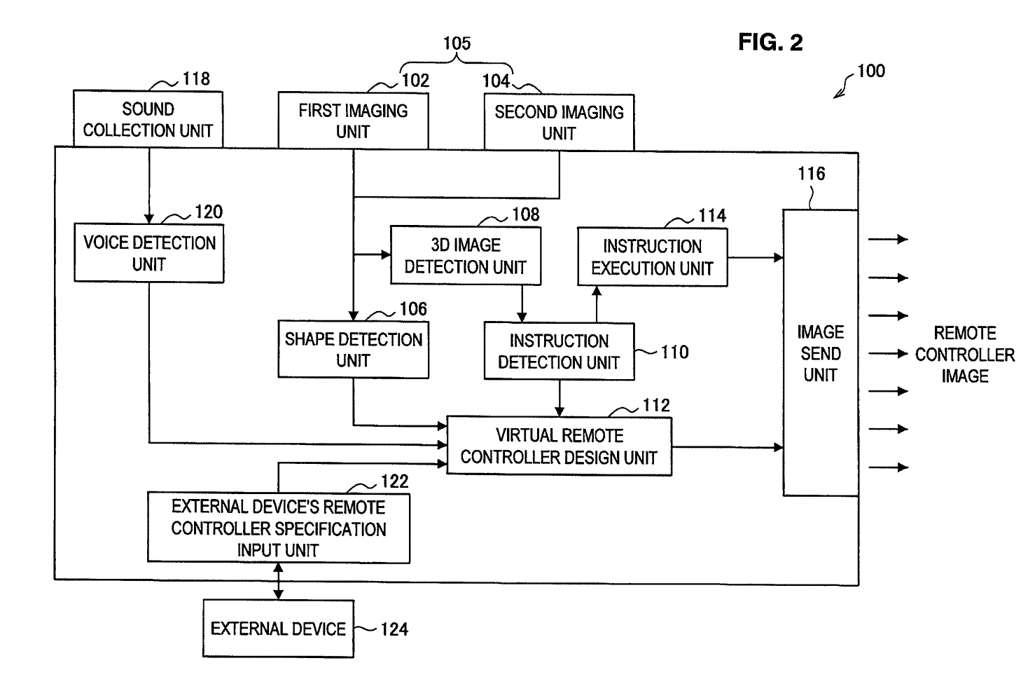

Next, a functional structure of the television 100 according to one embodiment of the present invention will be described. FIG. 2 is a block diagram showing one example of the functional structure of the television 100 according to the present embodiment.

As shown in FIG. 2, the television 100 mainly includes a first imaging unit 102, a second imaging unit 104, a shape detection unit 106, a 3D image detection unit 108, an instruction detection unit 110, a virtual remote controller design unit 112, an instruction execution unit 114 and an image send unit 116. The television 100 further includes a sound collection unit 118 and a voice detection unit 120 as the functions for voice recognition. Moreover, the television 100 further includes an external device's remote controller specification input unit 122 as a function of acquiring a remote controller specification of an external device 124.

The respective function units configuring the television 100 are controlled by a central processing unit (CPU) to perform various functions. Further, the functional structure of the television 100 shown in FIG. 2 is one example for explaining the present embodiment and the present invention is not limited thereto. In other words, in addition to the functional structure shown in FIG. 2, the television 100 can further include various functions such as broadcast reception function, communication function, voice output function, external input/output function and record function. In the following explanation, the respective functional structure units shown in FIG. 2 will be described in detail around the processings for the virtual remote controller 200 as the characteristics of the present embodiment.

### (First Imaging Unit 102, Second Imaging Unit 104)

As stated above, the television 100 according to the present embodiment takes an image of a user's operation by the imaging device to perform a processing depending on the user's operation contents. The first imaging unit 102 and the second imaging unit 104 are imaging devices provided in the television 100.

The first imaging unit 102 and the second imaging unit 104 (which may be also referred to as imaging unit 105 simply) are made of an optical system such as lens for image-forming a light from a subject on an imaging face, an imaging device such as charged coupled device (CCD) having an imaging face, and the like. The imaging unit 105 converts a subject image captured through the lens into an electric signal and outputs the signal. The imaging device provided in the imaging unit 105 is not limited to the CCD, and may be complementary metal oxide semiconductor (CMOS) or the like, for example. Further, a video signal taken by the imaging unit 105 is converted into a digital signal by an AD converter (not shown) and then transferred to the shape detection unit 106 or the 3D image detection unit 108.

The television 100 according to the present embodiment includes the two imaging devices, but the present invention is not limited to the structure. As stated above, the television 100 detects a user's operation on the virtual remote controller 200, which has been taken by the imaging unit 105, and performs a processing corresponding to the operation. Thus, in the present embodiment, there are provided the two imaging devices for more accurately recognizing a user's small motion on the virtual remote controller 200. Thus, the television 100 may include one or three or more imaging devices depending on required quality or spec.

### (Shape Detection Unit 106)

The shape detection unit 106 detects, for example, the face as part of the user's body contained in a video region taken by the imaging unit 105. As stated above, the television 100 according to the present embodiment is characterized by presenting an optimal virtual remote controller 200 suitable for the user. Thus, the television 100 recognizes the user's face contained in the video taken by the imaging unit 105 and presents the virtual remote controller 200 suitable for the recognized user.

The shape detection unit 106 can detect the face region contained in the video taken by the imaging unit 105 and determine whether the face region matches with a previously registered user's face, for example. The face detection method may employ, for example, support vector machine, boosting, neural network, Eigen-Faces and the like, but is not limited to a specific method. Further, the shape detection unit 106 may improve an accuracy of detecting the user's face contained in the taken image by utilizing skin color detection, infrared sensor or the like.

The result of the user's face detection by the shape detection unit 106 is transferred to the virtual remote controller design unit 112 described later. In response thereto, the virtual remote controller design unit 112 can present the virtual remote controller 200 adapted to the user specified by the shape detection unit 106 to the user via the image send unit 116.

### (3D Image Detection Unit 108)

The 3D image detection unit 108 detects a user's operation on the virtual remote controller 200 based on the video taken by the imaging unit 105. As described above, the television 100 according to the present embodiment is characterized by performing a processing corresponding to the user's operation contents on the virtual remote controller 200 in response to a user's intuitive operation on the virtual remote controller 200 displayed as 3D image. Thus, the television 100 detects the user's operation on the virtual remote controller 200 based on the video taken by the imaging unit 105 to change a display of the virtual remote controller 200 depending on the detection result or to perform various functions provided in the television 100 such as channel change.

The 3D image detection unit 108 can detect a user's hand motion based on a so-called frame differential method for extracting a video difference between a predetermined frame taken by the imaging unit 105 and a previous frame by one of the frame, for example. As stated above, the television 100 includes the two imaging devices. Thus, the 3D image detection unit 108 can image-form an object on two sensors in the two optical systems (lenses) and calculate a distance to the object by which position on the sensors the object has been image-formed.

Although the 3D image detection unit 108 may include more complicated detection function to recognize a user's motion more accurately, the present invention does not intend to improve the user's motion detection accuracy and therefore the details thereof will be omitted. In other words, the user's motion detection method by the 3D image detection unit 108 is not limited to a specific detection method as long as it can detect a user's motion within an imaging region by the imaging unit 105.

A result of the user's motion detection by the 3D image detection unit 108 is transferred to the instruction detection unit 110 described later.

### (Instruction Detection Unit 110)

The instruction detection unit 110 recognizes the user's operation contents on the virtual remote controller 200 based on the user's motion detection result transferred from the 3D image detection unit 108 and transfers the recognition result to the instruction execution unit 114 or the virtual remote controller design unit 112.

The instruction detection unit 110 can recognize the user's operation contents on the virtual remote controller 200 based on the user's motion and the positional relationship of the virtual remote controller 200 presented to the user, for example. When recognizing that the user has pressed a predetermined channel button arranged on the virtual remote controller 200, for example, the instruction detection unit 110 instructs the instruction execution unit 114 to switch to the channel. In response thereto, the instruction execution unit 114 can transmit the channel switch instruction to each functional structure unit provided in the television 100.

When determining that the virtual remote controller 200 to be presented to the user needs to be changed depending on the user's operation contents on the virtual remote controller 200, the instruction detection unit 110 instructs the virtual remote controller design unit 112 to switch a display of the virtual remote controller 200. In response thereto, the virtual remote controller design unit 112 can change a color or shape of the user-pressed button of the virtual remote controller 200 or change the display to a virtual remote controller 200 having a shape most suitable for the user-desired function of the television 100.

### (Virtual Remote Controller Design Unit 112)

The virtual remote controller design unit 112 determines a kind of the virtual remote controller 200 to be presented to the user, or a kind or position of the operation buttons arranged on the virtual remote controller 200, and instructs the image send unit 116 to display the virtual remote controller 200. As stated above, the television 100 according to the present embodiment can present the virtual remote controller 200 adapted to the user utilizing the television 100 or appropriately change the virtual remote controller 200 to be presented to the user depending on the user's operation on the virtual remote controller 200. Thus, the television 100 three-dimensionally displays the virtual remote controller 200 adapted to the user specified by the shape detection unit 106 or appropriately updates the display of the virtual remote controller 200 in response to the instruction by the instruction detection unit 110.

The user can previously register an optimal remote controller adapted for him/herself in the television 100, for example. For example, an elderly person or child can previously register a remote controller shape in which only simple operation buttons for channel change or volume adjustment are arranged in the television 100. A user frequently viewing specific channels may previously register a remote controller shape in which only the operation buttons corresponding to his/her preferred channels are arranged in the television 100. The virtual remote controller design unit 112 can generate a virtual remote controller 200 in a remote controller shape previously registered by the user specified by the shape detection unit 106 and present the virtual remote controller 200 to the user via the image send unit 116 according to the detection result transferred from the shape detection unit 106.

The user can give an instruction of a predetermined processing to the television 100 by intuitively moving his/her finger on the virtual remote controller 200 presented by the television 100 like when operating a typical physical remote controller main body. The user can instruct the television 100 to change a channel by pressing a channel button arranged on the virtual remote controller 200, for example. However, in the present embodiment, since the virtual remote controller 200 is just an unsubstantial pseudo 3D image, there can occur a problem that it is difficult for the user to determine whether the operation contents of the virtual remote controller 200 have been successfully transferred to the television 100.

The television 100 according to the present embodiment can eliminate the above problem. As stated above, after the user's operation on the virtual remote controller 200 is detected by the 3D image detection unit 108, an instruction for a processing corresponding to the user's operation contents is transferred to the virtual remote controller design unit 112 by the instruction detection unit 110. The virtual remote controller design unit 112 changes the display of the virtual remote controller 200 presented to the user according to the instruction contents transferred from the instruction detection unit 110. The virtual remote controller design unit 112 can generate a remote controller image in which a color or shape of the user-operated button is changed, and change the display of the virtual remote controller 200 presented to the user, for example. Thus, the user can recognize that his/her operation contents on the virtual remote controller 200 have been accurately transferred to the television 100.

The user can instruct the television 100 to change to the virtual remote controller 200 corresponding to a predetermined mode by pressing a predetermined mode button arranged on the virtual remote controller 200. In this case, the virtual remote controller design unit 112 can change the display of the virtual remote controller 200 presented to the user into the virtual remote controller 200 in a remote controller shape corresponding to the user-selected mode according to the instruction contents transferred from the instruction detection unit 110. In other words, the television 100 can present to the user the virtual remote controller 200 in a remote controller shape optimally suitable to the function of the user's currently using television 100 in response to the user's operation on the virtual remote controller 200.

### (Instruction Execution Unit 114)

The instruction execution unit 114 instructs the respective functional structure units to execute various functions provided in the television 100 in response to the instruction from the instruction detection unit 110. As stated above, the television 100 according to the present embodiment is characterized by performing the processing depending on the user's operation contents on the virtual remote controller 200 in response to the user's intuitive operation on the virtual remote controller 200 displayed as 3D image. Further, after the user's operation contents on the virtual remote controller 200 are determined by the imaging unit 105, the 3D image detection unit 108 and the instruction detection unit 110 described above, an instruction of executing a predetermined processing is transferred from the instruction detection unit 110 to the instruction execution unit 114.

In response thereto, the instruction execution unit 114 can instruct the respective functional structure units of the television 100 to perform various processings depending on the user's operation contents on the virtual remote controller 200. The instruction execution unit 114 can instruct the respective functional structure units to perform various processings such as channel change, volume adjustment, power OFF, mode switching, data playback, recording reservation, program guide acquisition and page forwarding according to the user's operation contents on the virtual remote controller 200, for example. When changing the display along with the execution of the processing, the instruction execution unit 114 can instruct the image send unit 116 to switch the display.

### (Image Send Unit 116)

The image send unit 116 three-dimensionally displays user-viewing program, playback data, virtual remote controller 200 and the like. In other words, the image send unit 116 displays an image of the three-dimensional virtual remote controller 200 in a remote controller shape generated by the virtual remote controller design unit 112 to the user taken by the imaging unit 105. Further, the image send unit 116 may three-dimensionally display a program, a playback video by an externally-connected playback device, or the like to the user, for example, and the kind of the video displayed by the image send unit 116 is not limited to a specific video.

Furthermore, as stated above, the method for presenting a 3D video to the user includes a method in which the user puts a pair of glasses having different polarization characteristics for each glass, or a method which does not need a pair of glasses by utilizing disparity barrier, lenticular lens, holography system or the like. However, in the present embodiment, the 3D image display method is not limited to a specific method as long as it can present a 3D image of the remote controller to the user.

### (Sound Collection Unit 118)

The sound collection unit 118 includes a microphone for collecting a voice around the television 100, converting the voice into an electric signal and outputting the electric signal, or the like. As stated above, the television 100 according to the present embodiment can display the virtual remote controller 200 adapted to the user depending on the face detection result by the shape detection unit 106. However, when the user has registered his/her voice or the like in the television 100, for example, the television 100 may specify the user from the voice collected by the sound collection unit 118 and display the virtual remote controller 200 adapted to the specified user. The voice data collected through the microphone is converted into a digital signal and then transferred to the voice detection unit 120.

### (Voice Detection Unit 120)

The voice detection unit 120 compares the voice data transferred from the sound collection unit 118 with user's voice data previously registered in the television 100 to specify the user utilizing the television 100. The voice detection unit 120 performs, for example, frequency analysis or the like at a predetermined interval of time on the voice data transferred from the sound collection unit 118 to extract a spectrum or other acoustic characteristic amount (parameter). The voice detection unit 120 recognizes the voice collected by the sound collection unit 118 based on the extracted parameter and a previously registered user's voice pattern. The voice recognition result by the voice detection unit 120 is transferred to the virtual remote controller design unit 112. In response thereto, the virtual remote controller design unit 112 can display the virtual remote controller 200 adapted to the user specified by the voice detection unit 120.

When the television 100 is in power-off, the virtual remote controller 200 is not being presented to the user. Thus, the user cannot operate the virtual remote controller 200 so that he/she cannot utilize the virtual remote controller 200 to power on the television 100. In this case, although the user can power on the television 100 by pressing the main power supply button 130 provided in the television 100 main body, for example, he/she needs complicated operations.

In this case, when detecting a predetermined voice corresponding to the power-on instruction for the television 100, the voice detection unit 120 may instruct the instruction execution unit 114 to power on the television 100. As a result, the user can power on the television 100 by clapping his/her hands “whump, whump” or generating a phrase of “power on”, for example. The processing performed depending on the voice detected by the voice detection unit 120 is not limited to the power-on processing on the television 100. In other words, the television 100 may perform various processings provided in the television 100 depending on the voice detected by the voice detection unit 120.

The voice recognition by the voice detection unit 120 is not limited to a specific recognition method, and may employ various systems capable of comparing and recognizing the voice data transferred to the voice detection unit 120 and the previously registered user's voice data.

### (External Device's Remote Controller Specification Input Unit 122)

The external device's remote controller specification input unit 122 acquires information on a remote controller specification of the external device 124 externally connected to the television 100 and transfers the information to the virtual remote controller design unit 112. As stated above, the television 100 can present the virtual remote controller 200 on which the operation buttons corresponding to various functions provided in the television 100 are arranged to the user. However, in recent years, in many cases, a television is connected with multiple external devices such as record/playback device, satellite broadcast reception tuner and speaker system, which operate in association with each other. There was a problem that since the respective remote controllers are prepared for the television and the external devices connected thereto, the user has to select an appropriate remote controller depending on the device to be utilized, which is complicated. Some remote controllers for television may arrange thereon the operation buttons corresponding to the functions of the record/playback device together, but there was a problem that many operation buttons are arranged on one remote controller, which is not convenient for the user.

The television 100 according to the present embodiment can solve the problems. In other words, the television 100 according to the present embodiment presents the virtual remote controller 200 as 3D image to the user, thereby freely changing the shape of the virtual remote controller 200, the arrangement of the buttons, and the like. In other words, the television 100 may display the virtual remote controller 200 corresponding to the record/playback device when the user wishes to operate the record/playback device, and may display the virtual remote controller 200 corresponding to the speaker system when the user wishes to operate the speaker system.

The external device's remote controller specification input unit 122 acquires the information on the executable functions from the external device 124 connected to the television 100 in association with the television 100 and transfers the information to the virtual remote controller design unit 112. In response thereto, the virtual remote controller design unit 112 can present the virtual remote controller 200 on which the operation buttons corresponding to the executable functions of the external device 124 in association with the television 100 are arranged to the user. Thus, the television 100 can perform predetermined functions provided in the external device 124 in association with the television 100 depending on the user's operation contents on the virtual remote controller 200 corresponding to the external device 124. In other words, the user can operate the television 100 and the external device 124 only by intuitively moving his/her finger like when operating a typical remote controller without using multiple physical remote controllers.

The external device's remote controller specification input unit 122 can acquire the information on the remote controller from the external device 124, download the remote controller specification, or update the remote controller specification by updating the software, for example. Thus, even when a new external device 124 is connected to the television 100, the external device's remote controller specification input unit 122 only acquires the remote controller specification of the external device 124 so that the television 100 can present the virtual remote controller 200 corresponding to the external device 124 to the user.

There has been described above the functional structure of the television 100 according to the present embodiment in detail.

### 3. PROCESSING FLOW BY TELEVISION 100

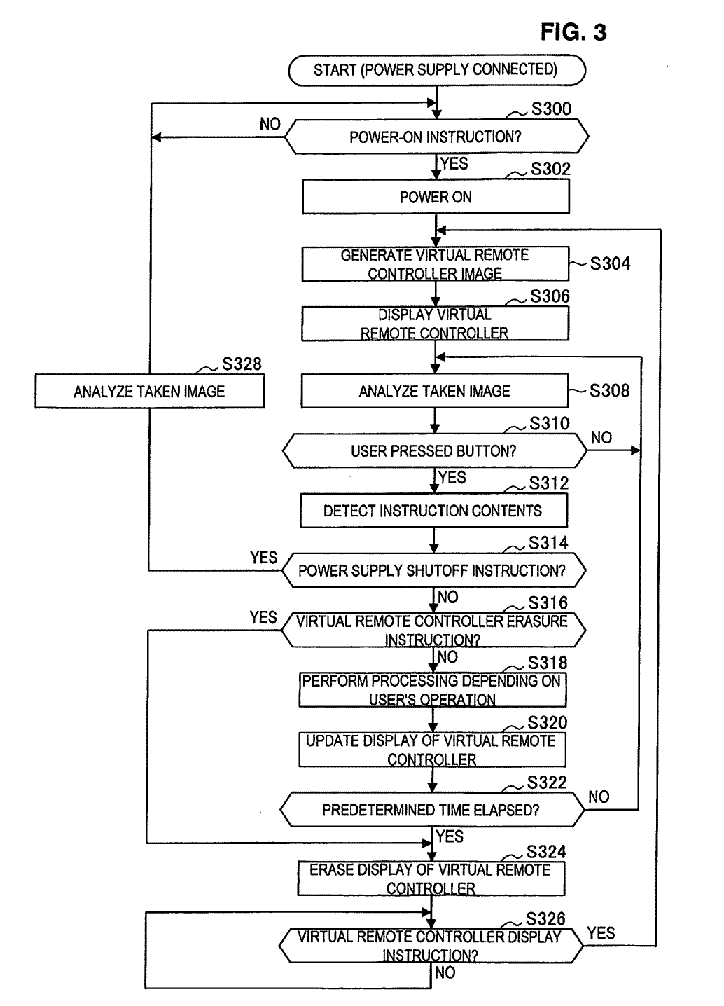

Next, a flow of a processing performed by the television 100 configured above will be described with reference to the flowchart of FIG. 3. FIG. 3 is a flowchart showing one example of a flow of a processing performed by the television 100. The processing flow shown in FIG. 3 is a flow of the processing which is continuously performed after the main power supply of the television 100 is connected to an electric outlet.

As shown in FIG. 3, after the main power supply is connected to an electric outlet, the television 100 determines in step 300 whether the user has made a power-on instruction. As stated above, when the power supply of the television 100 is not powered, the virtual remote controller. 200 is not displayed. Thus, the user cannot instruct to power on the television 100 by utilizing the virtual remote controller 200. Thus, the television 100 can determine the power-on instruction from the user with a preset predetermined condition as trigger.

For example, when the user has simply pressed a physical main power supply button 130 provided in the television 100, the television 100 can determine that the power-on instruction has been made by the user. However, since the operation is complicated for the user, the television 100 may determine the power-on instruction from the user with other method.

For example, the television 100 may determine the power-on instruction from the user by the voice detection by the aforementioned voice detection unit 120. The television 100 can previously register, for example, a sound “whump, whump” of clapping user's hands or a user's voice saying “power on” as the voice for the power-on instruction. In this case, when it is determined that a voice collected via the sound collection unit 118 is “whump, whump” or a voice of “power on”, the voice detection unit 120 determines that the power-on instruction has been made from the user, and instructs the instruction execution unit 114 to power on the television 100.

Further, the television 100 may determine the power-on instruction from the user by a shape detection by the aforementioned shape detection unit 106, for example. The television 100 can previously register the user's face or a predetermined operation such as waving as videos for the power-on instruction. In this case, when detecting the registered user's face or predetermined operation from the video taken by the imaging unit 105, the shape detection unit 106 determines that the power-on instruction has been made from the user, and instructs the instruction execution unit 114 to power on the television 100.

Thus, the television 100 is in the power-on waiting state until it is determined in step 300 that the power-on instruction has been made. On the other hand, when it is determined in step 300 that the power-on instruction has been made, the television 100 powers on in step 302.

Next, the television 100 generates an image of the virtual remote controller 200 to be presented to the user in step 304. The image generation processing for the virtual remote controller 200 is performed by the virtual remote controller design unit 112 described above.

The virtual remote controller design unit 112 may generate an image of the virtual remote controller 200 adapted to the user who has made the power-on instruction, for example. In step 300 described above, when the user can be specified by the voice detection by the voice detection unit 120 or the detection result by the shape detection unit 106, the virtual remote controller design unit 112 can generate an image of the virtual remote controller 200 adapted to the specified user. The television 100 may previously register a remote controller shape or kind adapted for each user and display the remote controller shape or kind at the time of power-on, or may display the shape or kind of the virtual remote controller 200 last used as the virtual remote controller 200 adapted to the user at the time of power-on.

Next, in step 306, the television 100 three-dimensionally displays the image of the virtual remote controller 200 generated by the virtual remote controller design unit 112 via the image send unit 116 and presents the image to the user. At this time, the image send unit 116 may display the virtual remote controller 200 to the user detected based on the video taken by the imaging unit 105. After the virtual remote controller 200 is displayed to the user, the processings in steps 308 to 322 described later are continuously performed.

In step 308, the television 100 analyzes a video taken by the imaging unit 105. Specifically, the 3D image detection unit 108 detects a user's operation based on the video taken by the imaging unit 105 and transfers the detection result to the instruction detection unit 110.

In response thereto, the instruction detection unit 110 determines in step 310 whether the user's operation is to press a predetermined operation button arranged on the virtual remote controller 200. The instruction detection unit 110 determines whether the user has pressed a predetermined operation button arranged on the virtual remote controller 200 based on the user's motion detected by the 3D image detection unit 108 or the position of the virtual remote controller 200 displayed by the image send unit 116.

The television 100 continuously analyzes the taken image until it is determined in step 310 that the user has pressed a predetermined operation button arranged on the virtual remote controller 200. In other words, the virtual remote controller 200 is in the operation waiting state.

When it is determined in step 310 that the user has pressed a predetermined operation button arranged on the virtual remote controller 200, the instruction detection unit 110 recognizes the user's operation contents in step 312. As stated above, the instruction detection unit 110 can recognize which operation button the user has pressed based on the user's motion detected by the 3D image detection unit 108, the positions of the operation buttons arranged on the displayed virtual remote controller 200, and the like.

Next, in step 314, the instruction detection unit 110 determines whether the user's operation contents recognized in step 312 are a power shutoff instruction. The user can shut off the power supply of the television 100 by operating the virtual remote controller 200, of course. Thus, when determining that the user's operation contents on the virtual remote controller 200 are the power shutoff instruction, the instruction detection unit 110 instructs the instruction execution unit 114 to power on the television 100.

In response thereto, the instruction execution unit 114 shuts off the power supply of the television 100 in step 328. Thereafter, the virtual remote controller 200 is in the power-on waiting state until it is determined that the power-on instruction has been made in step 300 described above.

On the other hand, when it is determined in step 314 that the user's operation contents are not the power shutoff instruction, the instruction detection unit 110 determines in step 316 whether the user's operation contents recognized in step 312 are an instruction to erase the virtual remote controller 200. The user can erase the display of the virtual remote controller 200 by operating the virtual remote controller 200, of course. When selecting a predetermined channel and viewing a TV program, for example, the user can erase the display of the virtual remote controller 200. Thus, when determining that the user's operation contents for the virtual remote controller 200 are an operation of instructing to erase the display of the virtual remote controller 200, the instruction detection unit 110 instructs the instruction execution unit 114 to erase the display of the virtual remote controller 200.

In response thereto, the instruction execution unit 114 erases the display of the virtual remote controller 200 via the image send unit 116 in step 324. At this time, the television 100 may store the shape or button arrangement of the virtual remote controller 200 at the time of erasure. Thus, the television 100 can display the virtual remote controller at the previous time of the erasure of the display of the previous virtual remote controller 200 when the same user instructs to display the virtual remote controller 200 next time.

On the other hand, when it is determined in step 316 that the user's operation contents are not the instruction to erase the virtual remote controller 200, the instruction detection unit 110 transfers the information on the recognition result in step 312 to the instruction execution unit 114 and the virtual remote controller design unit 112.

In response thereto, in step 318, the instruction execution unit 114 instructs the respective functional structure units to perform predetermined processings provided in the television 100 and the external device 124 based on the recognition result transferred from the instruction detection unit 110. For example, when the instruction detection unit 110 recognizes that the user has pressed the channel change operation button, the instruction execution unit 114 instructs the image send unit 116 to display a program of the user-selected channel. In addition, the instruction execution unit 114 can instruct the respective functional structure units to perform the processings for various functions provided in the television 100 and the external device 124 based on the user's operation contents on the virtual remote controller 200. Consequently, the user can give an instruction of a predetermined processing to the television 100 or the external device 124 by pressing the operation button arranged on the displayed virtual remote controller 200.

Further, in step 320, the virtual remote controller design unit 112 generates an image of a new virtual remote controller 200 to be presented to the user based on the recognition result transferred from the instruction detection unit 110. For example, when the instruction detection unit 110 recognizes that the user has pressed the channel change operation button, the virtual remote controller design unit 112 generates the image of the virtual remote controller 200 for which a color or shape of the user-pressed operation button is changed, and displays the image of the virtual remote controller 200 via the image send unit 116. Thus, the user can visually recognize that his/her operation contents have been accurately transferred to the television 100.

When the instruction detection unit 110 recognizes that the user has pressed an operation button for operation mode switching of the external device 124, the virtual remote controller design unit 112 displays the virtual remote controller 200 on which the operation button of the external device 124 is arranged via the image send unit 116. Thus, the user can operate not only the television 100 but also the external device 124 by intuitively pressing the operation button arranged on the virtual remote controller 200.

Thereafter, the television 100 determines in step 322 whether the user's operation on the virtual remote controller 200 has not been detected for a preset processing time. When the user has not operated the virtual remote controller 200 for a certain period of time, for example, the television 100 may automatically erase the virtual remote controller 200. Thus, when it is determined in step 322 that the user has not operated the virtual remote controller 200 for a predetermined period of time, the television 100 erases the display of the virtual remote controller 200 via the image send unit 116 in step 324.

On the other hand, when it is determined in step 322 that the period of time for which the user has not operated the virtual remote controller 200 has not elapsed the preset predetermined period of time, the virtual remote controller 200 is continuously displayed and the processings in steps 308 to 320 described above are repeated.

The user can arbitrarily set or change the presence or absence of the processing of automatically erasing the virtual remote controller 200, a time until the virtual remote controller 200 is erased, and the like. Thus, the processing in step 322 is an arbitrary processing and is not necessarily needed, and the period of time to be determined is not limited to a specific period of time.

When the virtual remote controller 200 is erased in step 324, the television 100 determines in step 326 whether the user has instructed to display the virtual remote controller 200. As stated above, the user can erase the display of the virtual remote controller 200 when not using the virtual remote controller 200 such as when viewing a TV program. Thus, when wishing to utilize the virtual remote controller 200 again and to instruct the television 100 to perform a predetermined processing, the user needs to instruct the television 100 to display again the virtual remote controller 200. In this case, the television 100 can determine the user's instruction to display the virtual remote controller 200 with the preset predetermined condition as trigger like the determination as to the power-on instruction in step 300 described above.

For example, the television 100 can determine the user's instruction to display the virtual remote controller 200 based on the voice detection by the voice detection unit 120, or determine the user's instruction to display the virtual remote controller 200 based on the shape detection by the shape detection unit 106.

When it is determined in step 326 that the instruction to display the virtual remote controller 200 has been made, the virtual remote controller 200 is presented again to the user in steps 304 to 306. At this time, the television 100 may display the virtual remote controller 200 adapted to the user specified by the voice detection or the shape detection.

There has been described above in detail the flow of the processing continuously performed after the main power supply of the television 100 is connected to an electric outlet. By continuously performing the processing above, the television 100 can appropriately update the display of the virtual remote controller 200 or perform a predetermined processing depending on the user's operation contents in continuous response to the user's operation instruction in the power-on state of the television 100.

### 4. USAGE EXAMPLE OF TELEVISION 100

As stated above, the television 100 can perform a predetermined processing depending on a user's intuitive operation by displaying the virtual remote controller 200 without using a physical remote controller. Thus, the television 100 can also further improve the convenience of user's operability by devising the kind or display position of the virtual remote controller 200. There will be described below a usage example capable of further improving the convenience of the user's device operation by utilizing the characteristics of the television 100 according to the present embodiment.

As stated above, the television 100 can change the kind of the virtual remote controller 200 to be appropriately displayed or the kind of the operation button to be arranged in order to display the virtual remote controller 200 as 3D image. Thus, the user can easily change the shape or button arrangement of the virtual remote controller 200 by pressing the mode switching button displayed on the virtual remote controller 200.

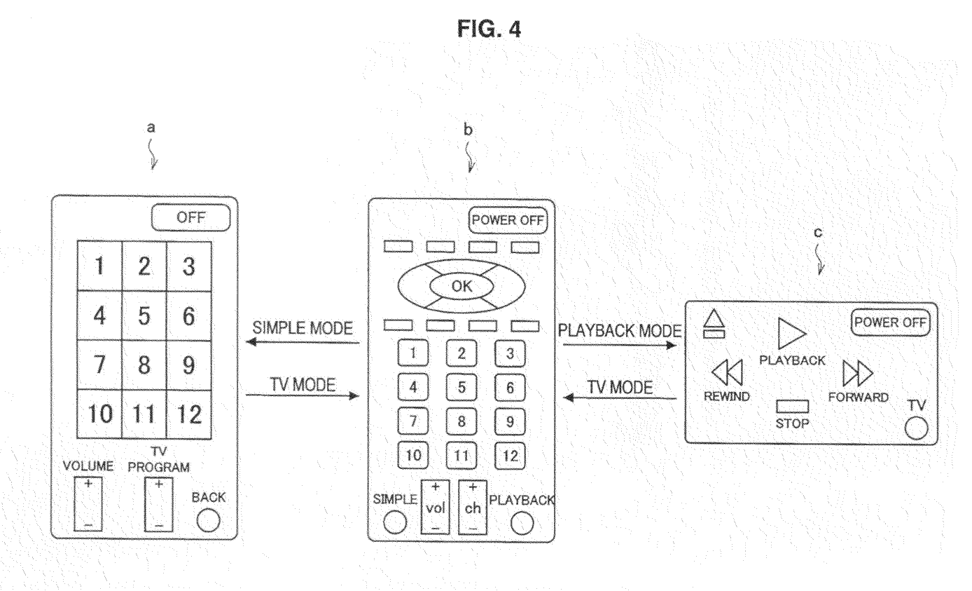

FIG. 4 is an explanatory diagram showing how the display of the virtual remote controller 200 is appropriately changed by the user. In the example of FIG. 4, for example, there is displayed the virtual remote controller 200 on which the operation buttons corresponding to the functions provided in a typical television 100 as shown in a diagram b in FIG. 4 are arranged. When the user presses the switching button to “simple mode” arranged at the lower left of the virtual remote controller 200, for example, the television 100 switches the display to the virtual remote controller 200 corresponding to the “simple mode” shown in a diagram a in FIG. 4 through the above processing. When the user presses the switching button to “playback mode” arranged at the lower right of the virtual remote controller 200, for example, the television 100 switches the display to the virtual remote controller 200 corresponding to the playback function of the external device 124 as shown in a diagram c in FIG. 4 through the above processing.

In this manner, the user can appropriately switch the display of the virtual remote controller 200 depending on the desired operation contents. Thus, since the user does not need to have multiple physical remote controllers unlike previously, the television 100 according to the present embodiment can improve the convenience of the user's device operation.

The operation buttons displayed on the virtual remote controller 200 corresponding to the playback mode shown in a diagram c in FIG. 4 are different depending on a specification of the external device 124 operating in association with the television 100. In the past, there was a problem that when a new external device is connected to a television, a new physical remote controller different from that for the television is needed, which is complicated for the user. On the contrary, in the case of the television 100 according to the present embodiment, if the information on the remote controller specification of the external device 124 is acquired, the virtual remote controller 200 corresponding to the newly-connected external device 124 can be also easily displayed. Even when multiple external devices 124 are connected to the television 100, if the information on the remote controller specifications of all the connected external devices 124 is acquired, the virtual remote controllers 200 corresponding to all the external devices 124 can be displayed.

Thus, even when multiple external devices 124 are connected to the television 100, the user does not need to use multiple physical remote controllers. In other words, the user instructs the television 100 to display the virtual remote controller 200 corresponding to an operation-desired device and presses the displayed virtual remote controller 200, thereby instructing also the external device 124 to perform a predetermined processing.

By utilizing the characteristic that the display of the virtual remote controller 200 can be appropriately changed, the television 100 can further improve the convenience of the user's device operation by displaying the virtual remote controller 200 adapted to the utilizing user.

The user can freely customize the shape of the virtual remote controller 200 adapted to his/herself or the operation buttons to be arranged and previously register the them in the television 100. The television 100 can specify the user utilizing the television 100 from the video taken by the imaging unit 105 based on the voice detection or the shape detection as described above. Thus, when the specified user has registered the virtual remote controller 200, the television 100 only displays the registered virtual remote controller 200.

Thus, the user can use the user-friendly unique virtual remote controller 200. In the past, there were prepared a physical remote controller on which complicated operation buttons are arranged and a physical remote controller on which simple operation buttons are arranged, and the multiple remote controllers are used for each user, for example, the former is used by a user familiar with the device and the latter is used by an elderly person or child. For the conventional physical remote controller, the preferred channels and the like could be set for user's preference. However, there was a problem that when one remote controller is used by multiple members of one family, the preferred channels of other family members are set in the remote controller, which is inconvenient for the user.

On the contrary, the television 100 according to the present embodiment can display the virtual remote controller 200 different for each user utilizing the television 100. In other words, even when one television 100 is used by multiple users, the optimal virtual remote controller 200 can be displayed for each user utilizing the television 100. Consequently, since multiple users do not need to use the same physical remote controller unlike previously, the television 100 according to the present embodiment can further improve the convenience of the user's device operation.

When multiple users use the television 100 at the same time, the television 100 may present the virtual remote controller 200 only to a specific user. For example, when multiple users are detected from the video taken by the imaging unit 105, the television 100 selects only one user and presents the virtual remote controller 200 only to the user.

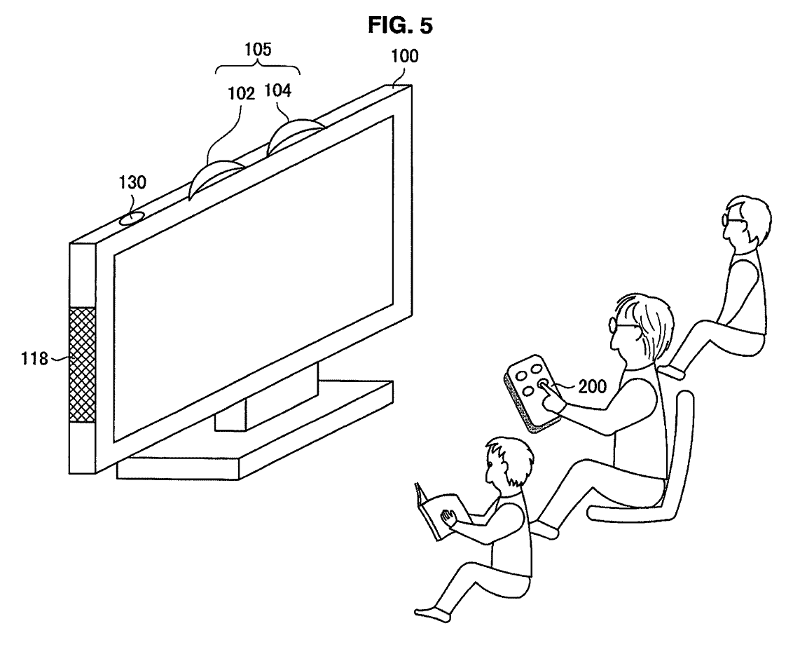

FIG. 5 is an explanatory diagram showing a concept for displaying the virtual remote controller 200 only to one user among multiple users. With reference to FIG. 5, it can be seen that although three users are present in the imaging region of the imaging unit 105, the virtual remote controller 200 is displayed only to the user sitting at the center. Thus, only the user sitting at the center presses the virtual remote controller 200, thereby instructing the television 100 to perform a predetermined processing. Further, the virtual remote controller 200 is not displayed to other users or the user sitting in front of the television 100 but not viewing the television 100. In other words, the television 100 can display the virtual remote controller 200 only to the user wishing to utilize the virtual remote controller 200, thereby further improving the convenience of the user's device operation.

The method for selecting a user to which the virtual remote controller 200 is displayed is not limited to a specific method and the television 100 can select a user to which the virtual remote controller 200 is displayed from various viewpoints. The television 100 may select a user appearing at the center of the taken image, a user performing a specific operation, or a user coinciding with the previously registered user as the user to which the virtual remote controller 200 is displayed.

When multiple users use the television 100 at the same time, the television 100 may present the virtual remote controllers 200 different for each user at the same time. As stated above, the television 100 can specify the user using the television 100 based on the detection result by the shape detection unit 106 or the voice detection unit 120 and the previously registered user information. Further, the television 100 can register the virtual remote controller 200 customized for each user or store the shape and the like of the virtual remote controller 200 which the user used last. Thus, the television 100 can display the optimal virtual remote controllers 200 for the respective multiple users specified in the imaging region of the imaging unit 105.

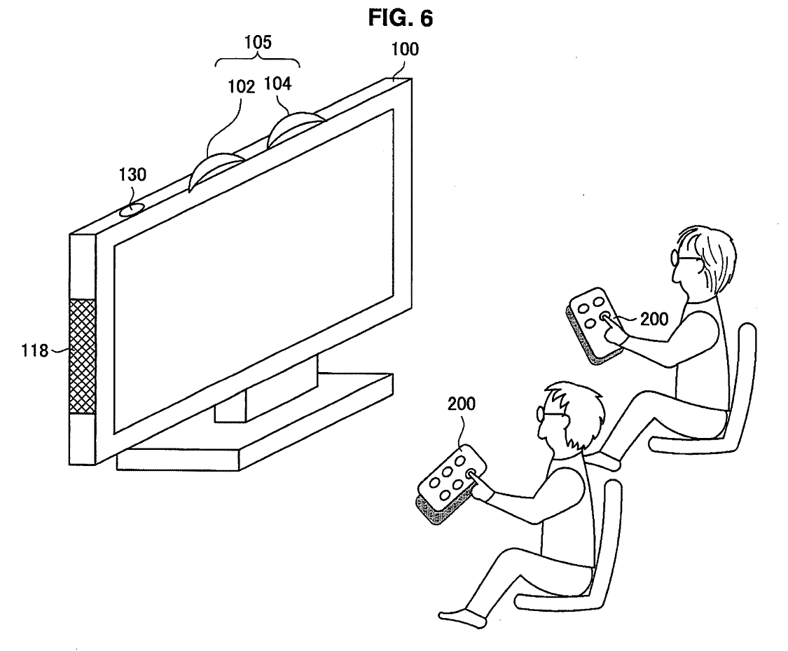

FIG. 6 is an explanatory diagram showing a concept for displaying the virtual remote controllers 200 different for the respective multiple users viewing the television 100 at the same time. With reference to FIG. 6, it can be seen that although two users are present in the imaging region of the imaging unit 105, the virtual remote controller 200 is displayed for each user. The virtual remote controllers 200 may be a customized virtual remote controller 200 previously registered in the television 100 by each user or a virtual remote controller 200 which each user used last.

In this manner, the television 100 can display the different virtual remote controllers 200 for the respective multiple users at the same time. Thus, also when some family members view the television 100, the television 100 can present the virtual remote controllers 200 adapted to each user to the respective users at the same time. Consequently, the multiple users do not need to set their preferred channels in one physical remote controller 200 unlike previously, and each user can use the virtual remote controller 200 having a most operable shape or button arrangement for him/herself. In other words, the television 100 according to the present embodiment can present the virtual remote controllers 200 optimal for the respective users at the same time without physical remote controllers, thereby further improving the convenience of the user's device operation.

As stated above, the virtual remote controller 200 presented by the television 100 to the user is not a physical remote controller but a pseudo 3D image. Thus, the television 100 can freely change the display position of the virtual remote controller 200. For example, in the case of a conventional physical remote controller, the user could not instruct the television to perform a predetermined processing at his/her current position without moving while carrying the remote controller in his/her hand. On the contrary, the television 100 according to the present embodiment can appropriately change the position at which the virtual remote controller 200 is displayed depending on a user's position or operation.

The television 100 may appropriately change the display position of the virtual remote controller 200 along with the position of a user's hand moving within the imaging region of the imaging unit 105, for example. Thus, even when the user changes the position to view the television 100, the virtual remote controller 200 is always being displayed to the user. Further, the television 100 may change the position at which the virtual remote controller 200 is displayed in response to a user's operation, for example. When the user moves his/her hand from right to left, for example, the television 100 may move the display of the virtual remote controller 200 from right to left. When the user performs an operation of grasping the virtual remote controller 200 in his/her hand, for example, the television 100 may change the display position of the virtual remote controller 200 in response to a subsequent motion of user's hand. An operation button for changing the display position of the virtual remote controller 200 is arranged on the virtual remote controller 200 so that the television 100 may change the display position of the virtual remote controller 200 depending on the operation contents when the user presses the operation button.

In this manner, the television 100 can appropriately change the display position of the virtual remote controller 200 as pseudo 3D image, thereby further improving the convenience of the user's device operation.

### 5. HARDWARE STRUCTURE OF INFORMATION PROCESSING APPARATUS

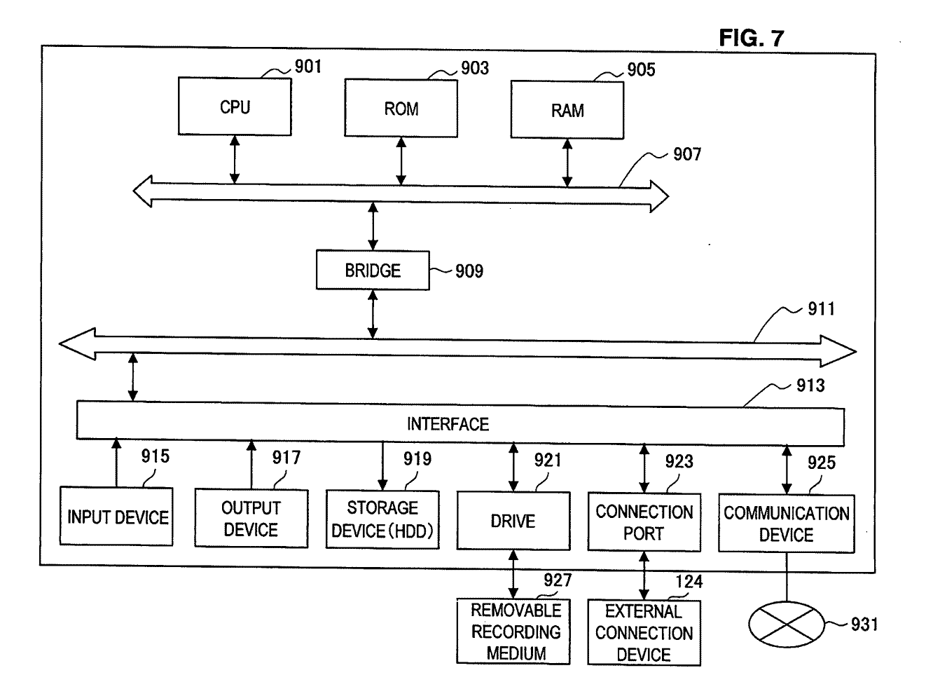

Next, a hardware structure of the information processing apparatus according to the present embodiment will be described in detail with reference to FIG. 7. FIG. 7 is a block diagram for explaining the hardware structure of the information processing apparatus according to the present embodiment.

The information processing apparatus according to the present embodiment mainly includes a CPU 901, a ROM 903, a RAM 905, a bridge 909, an interface 913, an input device 915, an output device 917, a storage device 919, a drive 921, a connection port 923 and a communication device 925.

The CPU 901 functions as a calculation processing device and a control device, and controls all or part of the operations within the information processing apparatus according to various programs recorded in the ROM 903, the RAM 905, the storage device 919 or a removable recording medium 927. The ROM 903 stores therein programs, calculation parameters and the like used by the CPU 901. The RAM 905 temporarily stores therein the programs used in the execution of the CPU 901, the parameters appropriately changed in their execution, and the like. These are interconnected via a host bus 907 configured with an internal bus such as CPU bus.

The input device 915 is an operation means operated by the user such as mouse, keyboard, touch panel, buttons, switches or lever. Further, the input device 915 is configured with an input control circuit for generating an input signal based on the information input by the user through the above operation means and outputting the signal to the CPU 901.

The output device 917 includes a display device such as CRT display, liquid crystal display, plasma display or EL display capable of three-dimensionally displaying the aforementioned virtual remote controller 200 and the like. Further, the output device 917 is configured with a device capable of aurally notifying the user of the acquired information, including a voice output device such as speaker.

The storage device 919 is a data storage device configured as one example of the storage unit of the information processing apparatus according to the present embodiment. The storage device 919 is configured with a magnetic storage device such as hard disk drive (HDD), a semiconductor storage device, an optical storage device, a magnetooptical storage device or the like.

The drive 921 is a reader/writer for recording medium and is incorporated in or externally attached to the information processing apparatus according to the present embodiment. The drive 921 reads out the information recorded in the removable recording medium 927 such as mounted magnetic disk, optical disk, magnetooptical disk or semiconductor memory and outputs the information to the RAM 905. Further, the drive 921 can write the data or the like in the mounted removable recording medium 927.

The connection port 923 is directed for directly connecting to the external device 924, such as USB port, optical audio terminal, IEEE1394 port, SCSI port or HDMI port. The external device 124 is connected to the connection port 923 so that the television 100 described above can acquire the information on the remote controller specification from the external device 124.

The communication device 925 is a communication interface configured with a communication device or the like for connecting to a communication network 931, for example. The communication device 925 is a wired or wireless LAN, Bluetooth, a router for optical communication, a router for ADSL, modems for various communications, or the like, for example. The communication network 931 connected to the communication device 925 is configured with a network connected in a wired or wireless manner, or the like, and may be Internet, home LAN, infrared communication, radio wave communication, satellite communication or the like, for example.

There has been shown above one example of the hardware structure capable of realizing the functions of the information processing apparatus according to one embodiment of the present invention. Each constituent described above may be configured with a general purpose member, or may be configured in hardware specified to the function of each constituent. Thus, the hardware structure to be utilized can be appropriately changed depending on a technical level when the present embodiment is performed.

### 6. CONCLUSIONS

There has been described above the information processing apparatus according to one embodiment of the present invention by way of example of the television 100. As described above, the information processing apparatus according to the present embodiment can present to a user a pseudo 3D image of the remote controller on which the operation buttons corresponding to various functions provided in the information processing apparatus are arranged as a virtual remote controller. Thus, the user does not need to use a physical remote controller. The information processing apparatus according to the present embodiment can detect a user's operation on the virtual remote controller by an imaging device. Thus, the user can instruct the information processing apparatus to perform a predetermined processing by intuitively pressing an operation button arranged on the virtual remote controller like when operating a physical remote controller. Furthermore, the information processing apparatus according to the present embodiment can appropriately change a kind or position of the virtual remote controller to be displayed. In other words, the information processing apparatus according to the present embodiment can display an optimal virtual remote controller for each user, display a virtual remote controller only to a specific user, display different virtual remote controllers for multiple users at the same time, or change the position of a virtual remote controller depending on the user's position. As described above, the information processing apparatus according to the present embodiment performs a predetermined processing depending on user's intuitive operation contents on the virtual remote controller displayed as 3D image, thereby improving convenience of the user's device operation.

It should be understood by those skilled in the art that various modifications, combinations, sub-combinations and alterations may occur depending on design requirements and other factors insofar as they are within the scope of the appended claims or the equivalents thereof.

For example, the shape of the virtual remote controller 200, the kind or arrangement of the buttons, and the like exemplified in the above embodiment are merely examples for explaining the aforementioned embodiment, and the present invention is not limited thereto. In other words, the information processing apparatus freely changes the shape of the virtual remote controller 200, the kind or arrangement of the buttons, or acquires the remote controller specification of the external device depending on the user's customization setting, thereby displaying a new virtual remote controller 200. This is based on the fact that the virtual remote controller 200 as one characteristic of the present invention is just a pseudo 3D image, and could not be realized by a conventional physical remote controller.

For example, there has been described the user specification method by the shape detection unit 106 by way of example of the user's face detection in the above embodiment, but the present invention is not limited thereto. For example, the shape detection unit 106 may specify the user utilizing the television 100 by previously registering an image of user's hand or the like and comparing the registered image with a hand taken by the imaging unit 105. In this manner, as long as the shape detection unit 106 can specify the user by comparing the previously registered shape with the shape of part of the user's body contained in the video taken by the imaging unit 105, the shape to be determined is not limited to a specific shape.

The method for displaying a 3D image to the user, the motion detection method based on the imaging data, the voice recognition method and the like exemplified in the above embodiment are merely examples for explaining the above embodiment, and the present invention is not limited thereto. In other words, as long as a 3D image can be displayed to the user, whether to use a pair of glasses is not limited. Furthermore, as long as user's motion or voice can be recognized, the present invention is not limited to a specific method, and various detection methods or recognition methods can be utilized depending on a spec or the like required for the information processing apparatus.

In the present specification, the steps described in the flowcharts or sequence diagrams contain the processings performed in the described orders in time series and the processings performed in parallel or individually, though not necessarily performed in time series. The steps processed in time series can be appropriately changed in their order as needed, of course.

The present application contains subject matter related to that disclosed in Japanese Priority Patent Application JP 2008-308799 filed in the Japan Patent Office on December 2008, the entire content of which is hereby incorporated by reference.

What is claimed is:

1. An information processing apparatus comprising:
an image send unit for displaying a 3D image of a remote operation device as a virtual remote controller;
at least one imaging unit for taking an image of a user;
a 3D image detection unit for detecting a user's motion based on a video taken by the imaging unit;
an instruction detection unit for determining whether the user has pressed a predetermined operation button arranged on the virtual remote controller, based on a detection result by the 3D image detection unit and a position of the predetermined operation button arranged on the virtual remote controller displayed by the image send unit; and
an instruction execution unit for performing a predetermined processing corresponding to the user-pressed operation button on the virtual remote controller based on a determination result by the instruction detection unit.

2. The information processing apparatus according to claim 1, further comprising a shape detection unit for specifying a user in an imaging region of the imaging unit by detecting part of the user's body based on a video taken by the imaging unit and comparing the detected part with previously registered information on parts of the user's body,
wherein the image send unit displays a previously registered virtual remote controller adapted to the user specified by the shape detection unit.

3. The information processing apparatus according to claim 2, further comprising:
a sound collection unit such as microphone for collecting a voice; and
a voice detection unit for specifying a user who has generated the voice collected through the sound collection unit by comparing the voice collected by the sound collection unit with previously registered information on a user's voice,
wherein the image send unit displays a previously registered virtual remote controller adapted to the user specified by the voice detection unit.

4. The information processing apparatus according to claim 3, wherein the image send unit changes a shape of the virtual remote controller, and kinds or positions of operation buttons to be arranged on the virtual remote controller based on a determination result by the instruction detection unit.

5. The information processing apparatus according to claim 4, wherein the image send unit changes and displays a color and/or shape of only an operation button which is determined to have been pressed by the user in the instruction detection unit among the operation buttons arranged on the virtual remote controller.

6. The information processing apparatus according to claim 5, wherein the image send unit changes a display position of the virtual remote controller in response to the user's motion such that the virtual remote controller is displayed to the user detected by the 3D image detection unit.

7. The information processing apparatus according to claim 6, wherein the image send unit changes a display position of the virtual remote controller depending on a user's operation when the user's operation detected by the 3D image detection unit matches with a previously registered predetermined operation corresponding to an instruction of changing the display position of the virtual remote controller.

8. The information processing apparatus according to claim 7, wherein the instruction execution unit powers on the information processing apparatus when a user's operation detected by the 3D image detection unit matches with a previously registered predetermined operation corresponding to the power-on instruction.

9. The information processing apparatus according to claim 8, wherein the instruction execution unit powers on the information processing apparatus when a sound detected by the voice detection unit matches with a previously registered predetermined sound corresponding to the power-on instruction.

10. The information processing apparatus according to claim 9, further comprising an external device's remote controller specification input unit for acquiring information on a remote controller specification of an external device operating in association with the information processing apparatus,
wherein the image send unit displays a virtual remote controller on which operation buttons corresponding to predetermined functions provided in the external device are arranged, based on the information on a remote controller specification of the external device.

11. The information processing apparatus according to claim 1, wherein when multiple users are present in an imaging region of the imaging unit, the image send unit displays a previously registered virtual remote controller adapted to only one user to the user.

12. The information processing apparatus according to claim 1, wherein when multiple users are present in an imaging region of the imaging unit, the image send unit displays previously registered virtual remote controllers adapted to the respective users to each user at the same time.

13. An information processing method comprising the steps of:
displaying a 3D image of a remote operation device as a virtual remote controller;
continuously taking an image of a user by at least one imaging unit;
detecting a user's motion based on a video taken by the imaging step;
determining whether the user has pressed a predetermined operation button arranged on the virtual remote controller based on a detection result by the 3D image detection step and a position of the predetermined operation button arranged on the virtual remote controller displayed by the image send step; and
executing a predetermined processing corresponding to the user-pressed operation button on the virtual remote controller based on a determination result by the instruction detection step.
